(19) United States
(12) Patent Application Publication
(10) Pub. No.: US 2014/0211597 A1
(43) Pub. Date: Jul. 31, 2014

(54) ELECTRONIC DEVICE AND METHOD OF CONTROLLING ALARM CLOCK FUNCTION

(71) Applicant: CHI MEI COMMUNICATION SYSTEMS, INC., New Taipei (TW)

(72) Inventors: JIUN-RU HOU, New Taipei (TW); LIU-WEI WU, New Taipei (TW); HSIN-CHANG LAI, New Taipei (TW); HAN-ZEN CHANG, New Taipei (TW)

(73) Assignee: CHI MEI COMMUNICATION SYSTEMS, INC., New Taipei (TW)

(21) Appl. No.: 13/948,243

(22) Filed: Jul. 23, 2013

(30) Foreign Application Priority Data
Jan. 28, 2013 (TW) 102103041

(51) Int. Cl. G04G 13/02

(52) U.S. Cl. CPC G04G 13/021
USPC 368/251

(57) ABSTRACT

An electronic device which includes an alarm clock function includes a gravity sensor. The gravity sensor detects X acceleration values of an X-axis, Y acceleration values of a Y-axis, and Z acceleration values of a Z-axis in relation to the electronic device. The electronic device determines a first average acceleration value of X acceleration values, a second average acceleration value of Y acceleration values, and a third average acceleration value of Y acceleration values. When a current time of the electronic device matches an alarm time of an alarm clock, the electronic device detects whether a user of the electronic device is awakened by determining whether the first average acceleration value, or the second average acceleration value, or the third average acceleration value is greater than a predetermined value . If the user is not awakened, the electronic device activates the alarm clock again to awaken the user.

### BACKGROUND

1. Technical Field

Embodiments of the present disclosure relate to alarm systems and methods, and more particularly to an electronic device and a method of controlling alarm clock function of the electronic device.

2. Description of Related Art

Electronic devices (such as mobile phones) often have an alarm function. Using the alarm function, a user of an electronic device can set an alarm clock to remind himself/herself of something (e.g., awake him/her from sleep) at a specific time. When a current time of the electronic device matches the specified time, the alarm clock is activated, and the user may select to turn off the alarm clock. However, the user may accidentally turn off the alarm clock so that the alarm clock may not ring again. As a result, without the reminder of the alarm clock, the user may forget to do important things in time.

### BRIEF DESCRIPTION OF THE DRAWINGS

FIG. 1 is a block diagram of one embodiment of an electronic device including an alarm clock control system.

FIG. 2 is a block diagram of one embodiment of function modules of the alarm clock control system in the electronic device of FIG. 1.

FIG. 3 and FIG. 4 illustrate a flowchart of one embodiment of a method of controlling an alarm clock function in the electronic device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

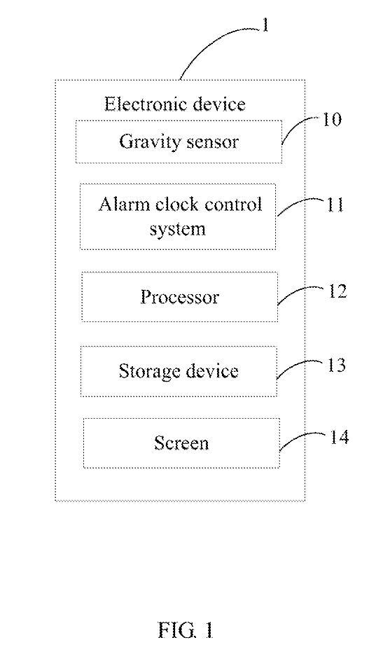

FIG. 1 is a block diagram of one embodiment of an electronic device 1. The electronic device 1 includes a gravity sensor (G-sensor) 10 and an alarm clock control system 11 (hereinafter “the system 11”). The electronic device 1 may be a telephone or a personal digital assistant (PDA), for example. The electronic device 1 may further include components such as a processor 12, a storage device 13, and a screen 14 The electronic device 1 may be configured in a number of other ways in other embodiments and may include other or different components from those shown in FIG. 1.

In one embodiment, the G-sensor 10 detects acceleration values of the electronic device 1. The system 11 sets an alarm clock. When a current time of the electronic device 1 matches an alarm time of the alarm clock, the system 11 automatically detects whether a user of the electronic device 1 is awakened according to the acceleration values detected by the G-sensor 10, and activates the alarm clock to wake the user up in response to a determination that the user is not awakened.

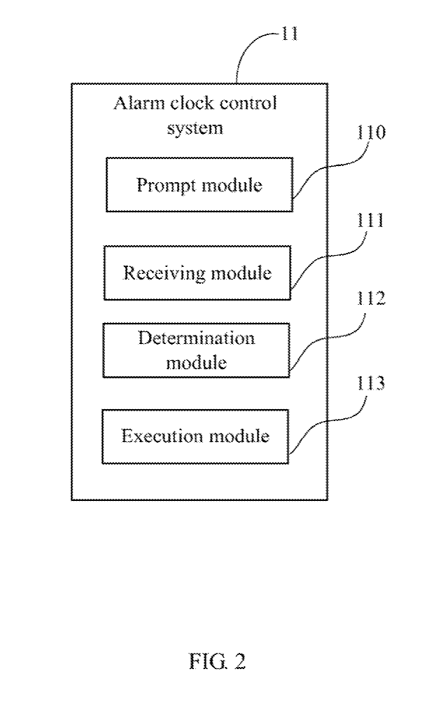

The system 11 includes a number of function modules (depicted in FIG. 2). The function modules may include computerized codes in the form of one or more programs, which are stored in the storage device 13. The processor 12 executes the computerized codes of the function modules, to provide the aforementioned function of the system 11. In one embodiment, the storage device 13 may include some type(s) of computer-readable non-transitory storage medium, such as a hard disk drive, a compact disc, a digital video disc, or a tape drive.

In one embodiment, the G-sensor 10 detects the acceleration values in respect of an X-axis, a Y-axis and a Z-axis. The X-axis is a horizontal axis of the screen 14 of the electronic device 1. The Y-axis is a vertical axis of the screen 14 and the Z-axis is on a line which extends straight up and straight down perpendicularly from a middle of the screen 14.

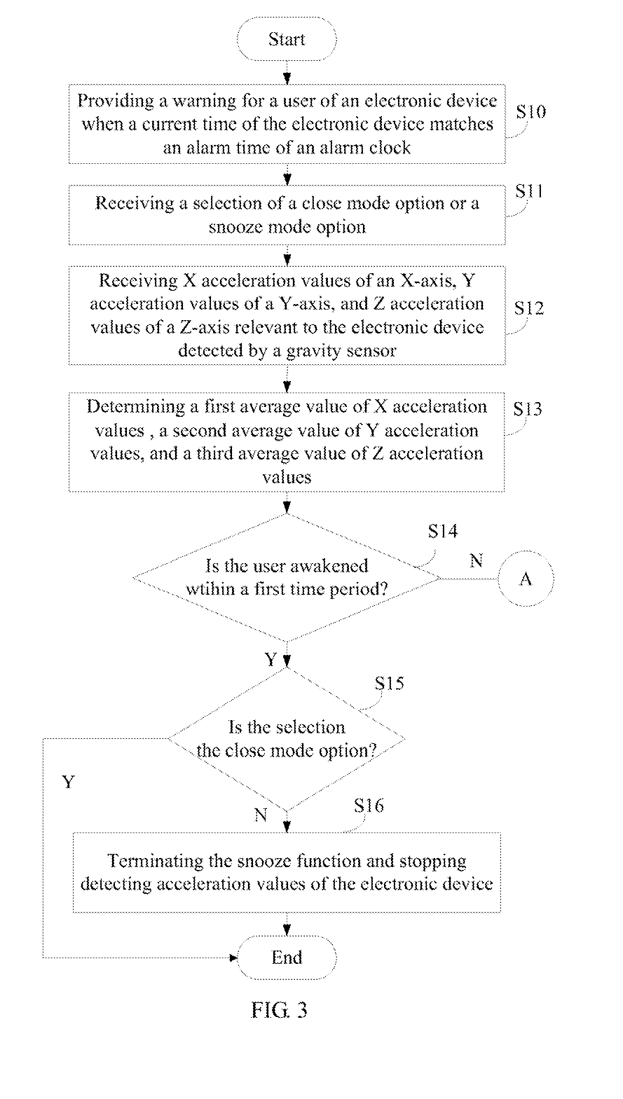

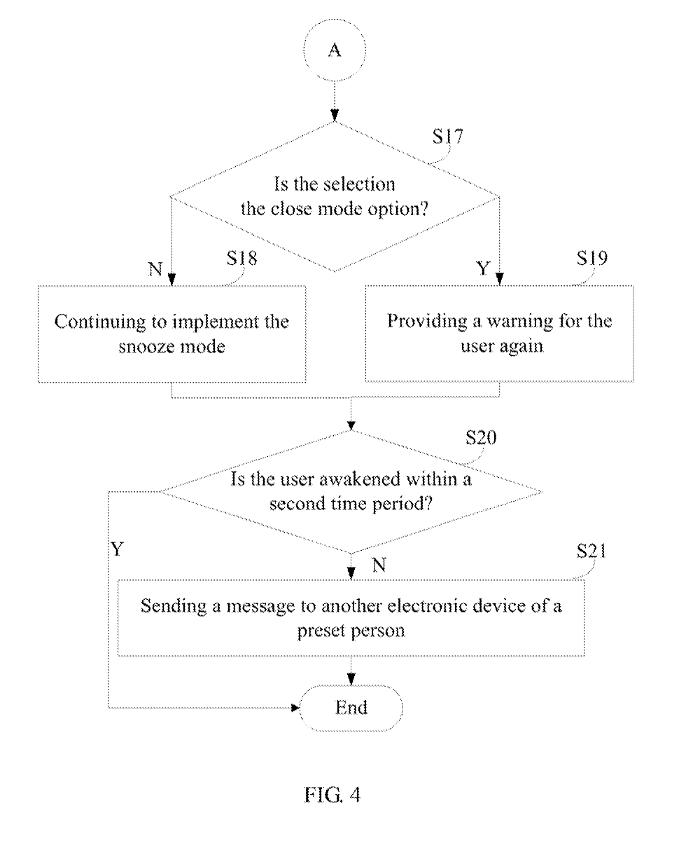

FIG. 2 is a block diagram of one embodiment of function modules of the system 11. In one embodiment, the system 11 may include a prompt module 110, a receiving module 111, a determination module 112, and an execution module 113. A detailed description of the function modules 110 to 113 is given in reference to FIG. 3 and FIG. 4.

FIG. 3 and FIG. 4 illustrate a flowchart of one embodiment of a method of controlling an alarm clock function in the electronic device of FIG. 1. Depending on the embodiment, additional steps in FIG. 3 and FIG. 4 may be added, others removed, and the ordering of the steps may be changed.

In step S10, when a current time of the electronic device 1 matches an alarm time of an alarm clock function, the prompt module 110 provides a warning to a user by a preset manner of the alarm clock, and displays a close mode option and a snooze mode option on the screen 14, for the user to select one. The close mode option allows the user to turn off the alarm clock altogether. The snooze mode option provides a warning for the user by the preset manner again after a time interval, such as ten minutes, for example. In one embodiment, the preset manner is a preset ring or a preset vibration of the electronic device 1.

In step S11, the selection of either the close mode option or the snooze mode option is received by the receiving module 111.

In step S12, the receiving module 111 receives X acceleration values of the X-axis, Y acceleration values of the Y-axis, and Z acceleration values of the Z-axis, which are in relation to the electronic device 1 and detected by the G-sensor 10.

In step S13, the determination module 112 determines a first average value of the X acceleration values, a second average value of the Y acceleration values, and a third average value of the Z acceleration values.

In step S14, the determination module 112 determines whether the user is awakened within a first time period (e.g., 5 minutes) by determining if any one of the first average acceleration value, the second average acceleration value, and the third average acceleration value is greater than a predetermined value in the first time period. If the first average acceleration value, or the second average acceleration value, or the third average acceleration value is greater than the predetermined value in the first time period, the determination module 112 determines that the user is awake in the first time period, then step S15 is implemented. If none of the first average acceleration value, the second average acceleration value, or the third average acceleration value are greater than the predetermined value, the determination module 112 determines that the user is still asleep, then step S17 is implemented.

In one embodiment, supposing that in the first predetermined time period, a number N of X acceleration values, a number N of Y acceleration values, and a number N of Z acceleration values are detected by the G-sensor 10. For example, ten X acceleration values, ten Y acceleration values, and ten Z acceleration values may be detected. Then, the first average acceleration value is obtained by dividing a sum of the X acceleration values by N (e.g., N=ten). The second average acceleration value is obtained by dividing a sum of the Y acceleration values by N. The third average acceleration value is obtained by dividing a sum of the Z acceleration values by N.

In step S14, if the determination module 112 determines that the user has been woken or is awake, step S15 is implemented, the determination module 112 determines whether the close mode has been selected. If the selection is the close mode option, the procedure ends. If the selection is the snooze mode option, step S16 is implemented, the execution module 113 terminates the snooze function and notifies the G-sensor 10 to stop detecting acceleration values of the electronic device 1, and the procedure ends.

In step S14, if the determination module 112 determines that the user is not awakened, that is, the user is still asleep, step S17 is implemented, the determination module 112 determines whether the selection is the close mode option. If the selection is the snooze mode option, step S18 is implemented, the execution module 113 continues to implement the snooze function, then the procedure goes to step S20. Otherwise, in step S17, if the selection is the close mode option, step S19 is implemented, the execution module 113 provides a prompt for the user again by the preset manner, then the procedure goes to step S20.

In step 20, the determination module 112 determines whether the user of the electronic device 1 is not awakened by the preset manner within a second time period (e.g. 30 minutes) by determining if all the X acceleration values, the Y acceleration values and the Z acceleration values equal zero in the second time period. If all the X acceleration values, the Y acceleration values and the Z acceleration values in the second predetermined time period equal zero, the determination module 112 determines that the user has not been woken up, then step S21 is implemented, and the execution module 113 sends a message to another electronic device of a preset person, to prompt the preset person to awaken the user of the electronic device 1. Otherwise, if all the X acceleration values, the Y acceleration values and the Z acceleration values in the second predetermined time period do not equal zero, the determination module 112 determines that the user has been woken up, and the procedure ends. In one embodiment, the second time period is more than the first time period.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computerized method being executed by at least one processor of an electronic device, the method comprising:
prompting a user of the electronic device by a preset manner of an alarm clock when a current time of the electronic device matches an alarm time of the alarm clock, and providing a close mode option for turning off the alarm clock and a snooze mode option for providing a snooze function on a screen of the electronic device;
receiving a selection of the close mode option or the snooze mode option;
receiving X acceleration values of an X-axis, Y acceleration values of a Y-axis, and Z acceleration values of a Z-axis in relation to the electronic device detected by a gravity sensor of the electronic device;
determining a first average value of the X acceleration values, determining a second average value of the Y acceleration values, and determining a third average value of the Z acceleration values;
determining whether the user is awakened by the preset manner within a first time period by determining whether any one of the first average acceleration value, the second average acceleration value, and the third average acceleration value is greater than a predetermined value within the first time period;
in response to a determination that the user is not awakened within the first time period and the snooze mode option is selected by the user, continuing to implement the snooze function; and
in response to a determination that the user is not awakened within the first time period and the close mode option is selected by the user, providing a prompt for the user again by the preset manner

2. The method according to claim 1, further comprising:
in response to a determination that the user is awakened and the snooze mode option is selected by the user, terminating the snooze function and notifying the gravity sensor to stop detecting the acceleration values of the electronic device.

3. The method according to claim 1, further comprising:
in response to a determination that the user is not awakened within the first time period, determining whether the user is awakened within a second time period by determining if all the X acceleration values, the Y acceleration values and the Z acceleration values equal zero within the second predetermined time period;
in response to a determination that all the X acceleration values, the Y acceleration values and the Z acceleration values equal zero within the second time period, determining that the user is not awakened within the second time period, and sending a message to another electronic device of a preset person, to prompt the preset person to wake up the user of the electronic device.

4. The method according to claim 3, wherein the second predetermined time period is more than the first predetermined time period.

5. An electronic device, comprising:
a gravity sensor;
a processor; and
a storage device storing one or more programs which is executed by the processor, causes the processor to:
prompt a user of the electronic device by a preset manner of an alarm clock when a current time of the electronic device matches an alarm time of the alarm clock, and providing a close mode option for turning off the alarm clock and a snooze mode option for providing a snooze function on a screen of the electronic device;
receive a selection of the close mode option or the snooze mode option;
receive X acceleration values of an X-axis, Y acceleration values of a Y-axis, and Z acceleration values of a Z-axis in relation to the electronic device detected by a gravity sensor of the electronic device;
determine a first average value of the X acceleration values, determining a second average value of the Y acceleration values, and determining a third average value of the Z acceleration values;
determine whether the user is awakened by the preset manner within a first time period by determining whether any one of the first average acceleration value, the second average acceleration value, and the third average acceleration value is greater than a predetermined value within the first time period;
continue to implement the snooze function in response to a determination that the user is not awakened within the first time period and the snooze mode option is selected by the user; and
provide a prompt for the user again by the preset manner in response to a determination that the user is not awakened within the first time period and the close mode option is selected by the user.

6. The electronic device according to claim 5, wherein the one or more programs further cause the processor to:
terminate the snooze function and notify the gravity sensor to stop detecting the acceleration values of the electronic device in response to a determination that the user is awakened and the snooze mode option is selected.

7. The electronic device according to claim 5, the storage device storing one or more programs which is executed by the processor, causes the processor to:
determine whether the user is awakened within a second time period by determining if all the X acceleration values, the Y acceleration values and the Z acceleration values equal zero within the second predetermined time period in response to a determination that the user is not awakened within the first time period.
determine that the user is not awakened within the second time period, and send a message to another electronic device of a preset person, to prompt the preset person to awaken the user of the electronic device in response to a determination that all the X acceleration values, the Y acceleration values and the Z acceleration values equal zero in the second time period.

8. The electronic device according to claim 7 , wherein the second predetermined time period is more than the first predetermined time period.

9. A non-transitory storage medium having stored thereon instructions that, when executed by a processor of a computing device, causes the processor to perform alarm clocks control method in the electronic device, wherein the method comprises:
prompting a user of the electronic device by a preset manner of an alarm clock when a current time of the electronic device matches an alarm time of the alarm clock, and providing a close mode option for turning off the alarm clock and a snooze mode option for providing a snooze function on a screen of the electronic device;
receiving a selection of the close mode option or the snooze mode option;
receiving X acceleration values of an X-axis, Y acceleration values of a Y-axis, and Z acceleration values of a Z-axis in relation to the electronic device detected by a gravity sensor of the electronic device;
determining a first average value of the X acceleration values, determining a second average value of the Y acceleration values, and determining a third average value of the Z acceleration values;
determining whether the user is awakened by the preset manner within a first time period by determining whether any one of the first average acceleration value, the second average acceleration value, and the third average acceleration value is greater than a predetermined value within the first time period;
in response to a determination that the user is not awakened within the first time period and the snooze mode option is selected by the user, continuing to implement the snooze function; and
in response to a determination that the user is not awakened within the first time period and the close mode option is selected by the user, providing a prompt for the user again by the preset manner.

10. The non-transitory storage medium according to claim 9, the method further comprises:
in response to a determination that the user is awakened and the snooze mode option is selected by the user, terminating the snooze function and notifying the gravity sensor to stop detecting the acceleration values of the electronic device.

11. The non-transitory storage medium according to claim 9, the method further comprises:
in response to a determination that the user is not awakened within the first time period, determining whether the user is awakened within a second time period by determining if all the X acceleration values, the Y acceleration values and the Z acceleration values equal zero within the second predetermined time period;
in response to a determination that all the X acceleration values, the Y acceleration values and the Z acceleration values equal zero within the second time period, determining that the user is not awakened within the second time period, and sending a message to another electronic device of a preset person, to prompt the preset person to wake up the user of the electronic device.

12. The non-transitory storage medium according to claim 11, the second predetermined time period is more than the first predetermined time period.
